(19) United States
(12) Patent Application Publication
(10) Pub. No.: US 2006/0209497 A1
(43) Pub. Date: Sep. 21, 2006

(54) Pad structure of wiring board and wiring board

(76) Inventors: Kazuhiko Ooi, Nagano (JP); Kenjiro Enoki, Nagano (JP); Sachiko Oda, Nagano (JP)

Correspondence Address: MORGAN & FINNEGAN, L.L.P., 3 WORLD FINANCIAL CENTER, NEW YORK, NY, 10281-2101, US

(21) Appl. No.: 10/549,079

(22) PCT Filed: Sep. 21, 2004
(86) PCT No.: PCT/JP04/14126

§ 371 Date: Sep. 12, 2005

(30) Foreign Application Priority Data
Oct. 3, 2003 (JP) 2003345179

(51) Int. Cl. H02B 1/00

(52) U.S. Cl. 361/600

(57) ABSTRACT

A pad structure for a circuit board including a phosphorus-containing nickel layer is provided, capable of improving a tensile strength of a solder member such as a solder ball mounted thereon or a foreign member soldered thereto. The pad structure (40) is a multi-layer plated structure provided in a conductor pattern of the substrate, for mounting the solder bump (20) thereon, and formed as part of the conductor pattern, including a metal layer (10) formed as part of the conductor pattern to constitute a pad body, a phosphorus-containing nickel layer (12) formed by an electroless nickel plating to be directly brought into contact with the metal layer, a copper layer (14) thinner than the nickel layer, formed on the nickel layer by an electroless copper plating, and a precious metal layer (16) formed on the copper layer by an electroless precious metal plating.

### TECHNICAL FIELD

The present invention relates to a pad structure for a circuit board, to a circuit board having such a pad structure and, more specifically, relates to a plated pad structure on which a solder member such as a solder ball is mounted or an external member is soldered.

### BACKGROUND ART

On a circuit board used for a semiconductor device or other devices, solder bumps as external connection terminals are mounted in a pad provided at one end of a conductor pattern formed on one surface of a substrate.

Such a pad can be formed as a multi-layer plated structure as described in Japanese Unexamined Patent Publication (Kokai) No. 2001-77528 (column 2, line 47 to column 4, line 18). This pad is illustrated in FIG. 6.

The pad 114 shown in FIG. 6 is formed of a nickel layer 102 directly coming into contact with a copper layer 100 forming a body of the pad 114, and a gold layer 104, thinner than the nickel layer, is provided thereon for the purpose of enhancing the corrosion resistance or the acid resistance.

Such a nickel layer 102 and a gold layer 104 may be formed by an electroless plating. Unlike electrolytic plating, when the nickel layer 102 and the gold layer 104 are formed by the electroless plating, there is no need to provide a pattern for feeding electric current exclusively used for the electrolytic plating, whereby it is possible to increase the degree of freedom of the design for the circuit pattern or others.

In this regard, a surface of a copper layer constituting a body of the pad 114 is covered with solder resist 105 except for a region in which the pad 114 is to be formed.

According to the plated structure of the pad 114 illustrated in FIG. 6, when the solder ball is mounted to the pad 114 and subjected to the reflowing treatment, Au forming the gold layer 104 diffuses to the molten solder, and Sn contained in the molten solder and Ni forming the nickel layer 102 form an Sn—Ni alloy layer to fix a solder bump 106 to the pad 114.

In this regard, when the nickel layer 102 is formed by electroless nickel plating, an electroless nickel plating solution, used as a plating solution, contains a phosphorus component for the purpose of preventing the plated film from being corroded, as described, for example, in Japanese Unexamined Patent Publication (Kokai) No. 11-354687. Accordingly, a phosphorus (P) component is contained in the nickel layer 102 formed by the electroless nickel plating.

The solder bump 106 formed by the reflowing treatment of the solder ball mounted to the pad 114 having the phosphorus-containing nickel layer 102 is, however, low in tensile strength, and the improvement thereof is desired.

Also, when an external member such as an external connection terminal of an electronic part is soldered to the pad 114 shown in FIG. 6, it is similarly desired to improve the tensile strength thereof.

### DISCLOSURE OF THE INVENTION

Accordingly, the problem to be solved by the present invention is to provide a plated structure for a pad capable of improving the tensile strength of a solder member such as a solder ball mounted to a pad having a phosphorus-containing nickel layer, or a soldered external member, and a circuit board including the same.

To solve the above-mentioned problem, the inventors of the present invention have observed a bonded area between the solder bump 106 and the pad after the solder bump 106 is mounted to the pad 114 having the phosphorus-containing nickel layer 102, and found that a structure of the boundary is as shown in FIG. 7, under an electronic microscope.

That is, in a boundary between the nickel layer 102 and the bump 106, there is an Sn-nickel alloy layer 108, and also in a boundary between the Sn—Ni alloy layer 108 and the nickel layer 102, there is a P-rich layer 110 thinner than the Sn—Ni alloy layer 108 and consisting of an Ni component and a P component richer than the former. The P-rich layer 110 and the Sn—Ni alloy layer 108 also have small voids 112, 112 . . . .

According to the observation through the electronic microscope of a pad 114 after the bump 106 having the above-mentioned structure in the bonded area has been drawn out, it has been found that the debonding occurs in the boundary between the Sn—Ni alloy layer 108 and the P-rich layer 110, as shown in FIG. 8.

Accordingly, the inventors of the present invention have determined that, for the purpose of improving the tensile strength of the bump mounted to the pad 114 having the phosphorus-containing nickel layer 102, it is effective to form a densest layer in the boundary between the solder bump and the pad 114 when the solder ball mounted to the lad 114 is subjected to the reflowing treatment, and have studied the same.

As a result, the inventors have found that a pad having a phosphorus-containing nickel layer formed on a pad body by the electroless plating, a copper layer formed on the nickel layer by the electroless copper plating and a gold layer formed on the copper layer by the electroless gold plating is capable of improving the tensile strength of a solder bump mounted on this pad, and thus, the present invention has been achieved.

According to the present invention, a pad structure for a circuit board provided in a conductor pattern, to which a solder member such as a solder ball is mounted or a foreign member is soldered, having a multi-layer plated structure, is provided and comprises a metal layer formed as part of said conductor pattern to be a pad body, a phosphorus-containing nickel layer formed by an electroless nickel plating to be directly brought into contact with said metal layer, a copper layer thinner than said nickel layer, formed on said nickel layer by an electroless copper plating, and a precious metal layer formed on said copper layer by an electroless precious metal plating.

Also, according to the present invention, a pad structure for a circuit board provided in a conductor pattern, to which a solder member such as a solder ball is mounted or a foreign member is soldered, having a multi-layer plated structure is provided, comprises a metal layer formed as part of said conductor pattern to be a pad body, a phosphorus-containing nickel layer formed by an electroless nickel plating to be directly brought into contact with said metal layer, a first precious metal layer formed on said nickel layer by an electroless precious metal plating, a copper layer thinner than said nickel layer, formed on said first precious metal layer by an electroless copper plating, and a second precious metal layer formed on said copper layer by an electroless precious metal plating.

Further, according to the present invention, a circuit board is provided and comprises a substrate body, a conductor pattern formed on said substrate body, having a pad in part thereof on which a solder member such as a solder ball is to be mounted or a foreign member is to be soldered, wherein said pad comprises a metal layer formed as part of said conductor pattern to be a pad body, a phosphorus-containing nickel layer formed by an electroless nickel plating to be directly brought into contact with said metal layer, a copper layer thinner than said nickel layer, formed on said nickel layer by an electroless copper plating, and a precious metal layer formed on said copper layer by an electroless precious metal plating.

Furthermore, according to the present invention, a circuit board is provided and comprises a substrate body, a conductor pattern formed on said substrate body, having a pad in part thereof on which a solder member such as a solder ball is to be mounted or a foreign member is to be soldered, wherein said pad comprises a metal layer formed as part of said conductor pattern to be a pad body, a phosphorus-containing nickel layer formed by an electroless nickel plating to be directly brought into contact with said metal layer, a first precious metal layer formed on said nickel layer by an electroless precious metal plating, a copper layer thinner than said nickel layer, formed on said first precious metal layer by an electroless copper plating, and a second precious metal layer formed on said copper layer by an electroless precious metal plating.

In the above-mentioned pad structure or the circuit board incorporating the same, said metal layer forming the pad body is formed of copper, and said precious metal layer is formed of gold, palladium or platinum.

While a reason why the tensile strength of the solder member such as a solder ball mounted on the pad, or foreign member soldered thereto is improved by the pad structure for the circuit board according to the present invention is not apparent, it can be surmised to be as follows:

In the prior art pad structure, a thin gold layer is formed directly on a phosphorus-containing nickel layer. For example, when a solder ball is mounted on the pad and subjected to the reflowing treatment, after gold (Au) forming the gold layer has been diffused in the molten solder, nickel (Ni) forming the nickel layer is rapidly diffused in the molten solder and mixed with tin in the molten solder to form an Sn—Ni alloy layer as well as to form a P-rich layer having a dense phosphorus component. As the P-rich layer is uneven in thickness, the concentration of the phosphorus component is also uneven.

If the reflowing treatment continues after such a P-rich layer has been formed, the diffusion speed of nickel into the molten solder becomes irregular because the diffusion of nickel from a thicker portion of the P-rich layer into the molten solder in comparison with a thinner portion thereof, causing the generation of micro-voids in the P-rich layer and the Si—Ni alloy layer.

Contrarily, according to the inventive plated structure for the circuit board, it is thought that, when the mounted solder ball is subjected to the reflowing treatment, copper (Cu) in the copper layer is diffused in the molten solder and mixed with Sn in the molten solder to form an Sn—Cu alloy layer which is capable of controlling the diffusion speed and diffusion amount of nickel from the nickel layer into the molten solder. Thus, the formation speed of the Sn—Ni alloy layer is controlled to be constant to prevent the P-rich layer from being formed as much as possible, whereby the generation of micro-voids in the Sn—Ni alloy layer is restricted. As a result, the boundary between the solder bump and the pad is formed as a dense layer to improve the tensile strength of the solder bump.

In such a manner, according to the present invention, it is possible to improve the tensile strength of a solder member such as a solder ball mounted on the pad or the foreign member soldered thereto, whereby the reliability of the finally assembled electronic equipment incorporating the inventive pads is improved.

### BRIEF DESCRIPTION OF THE DRAWINGS

FIG. 1 is a partial sectional view for explaining one embodiment of a plating structure for a pad according to the present invention;

FIG. 2 is a partial sectional view for explaining another embodiment of a plating structure for a pad according to the present invention;

FIG. 3 is a schematic view of a tensile strength tester for measuring a tensile strength of a solder bump, and a graph of the tensile strength measured thereby;

FIG. 4 is views for explaining states of the drawn-out solder bump and a graph showing the test results;

FIG. 5 is graphs showing the comparison of the test results between the embodiment shown in FIG. 2 and the prior art shown in FIG. 6;

FIG. 6 is a partial sectional view for explaining the plating structure for the prior art pad;

FIG. 7 is a trace of an electronic-microscopic photography showing a state of the bonded area between the pad shown in FIG. 6 and a solder bump mounted thereto; and

FIG. 8 is a trace of an electronic-microscopic photograph showing a state of the pad from which the solder bump bonded thereto, as illustrated in FIG. 6, has been drawn out.

### BEST MODE FOR CARRYING OUT THE INVENTION

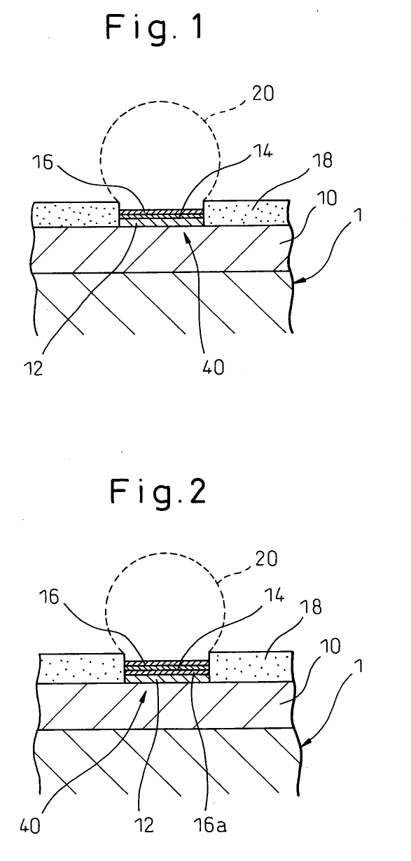

An embodiment of the inventive pad structure for a circuit board is shown in FIG. 1. A surface of a copper layer 10 constituting a body of a pad 40 shown in FIG. 1 is covered with a solder resist 18 except for part forming the pad. Note the copper layer 10 is formed as part of a conductor pattern provided on a substrate 1.

This pad 40 is a multi-layer plated structure having a nickel layer 12 directly coming into contact with the copper layer 10 forming the body of the pad 40, a copper layer 14 formed on the nickel layer 12 and a gold layer 16 formed as a precious metal layer on the copper layer 14.

Either of the nickel layer 12, copper layer 14 and gold layer 16 constituting such a multi-layer plated structure is formed by electroless plating so that a thickness becomes larger in this order; that is, the nickel layer 12 is thicker than the copper layer 14, and the copper layer 14 is thicker than the gold layer 16.

In this regard, the thickness of the gold layer 16 may be the same as or larger than that of the copper layer 14.

In the formation of the multi-layer plated structure, the electroless plating of the nickel layer 12 uses an electroless nickel plating solution containing a phosphoric compound. The concentration of phosphoric compound in such electroless nickel plating solution is preferably in a range from 6% to 8% by weight. The thickness of the P-contained nickel layer 12 formed by the electroless nickel plating using the electroless nickel plating solution is preferably in a range from 2 to 10 μm.

In the electroless copper plating for forming the copper layer 14 on this nickel layer 12, a Rochelle bath or an EDTA bath, widely used as an electroless plating solution, for producing a printed circuit board may be used. The thickness of the copper layer 14 formed by this electroless copper plating is preferably in a range from 0.01 to 1 μm.

Further, in the electroless gold plating for forming the gold layer 16 on the copper layer 14, a conventionally used strike gold plating bath may be used as the electroless gold plating solution. The gold layer 16 obtained by such an electroless gold plating serves to improve the corrosion resistance or the acid resistance of the pad, and is preferably within a range from 0.04 to 1 μm in thickness.

In this regard, the copper layer 10 constituting the body of the pad may be formed either by the electrolytic copper plating or by patterning a copper foil adhered to a surface of a resinous substrate 1.

A solder bump 20 can be formed on a surface of the pad 40 shown in FIG. 1 by mounting a solder ball thereon and reflowing the same.

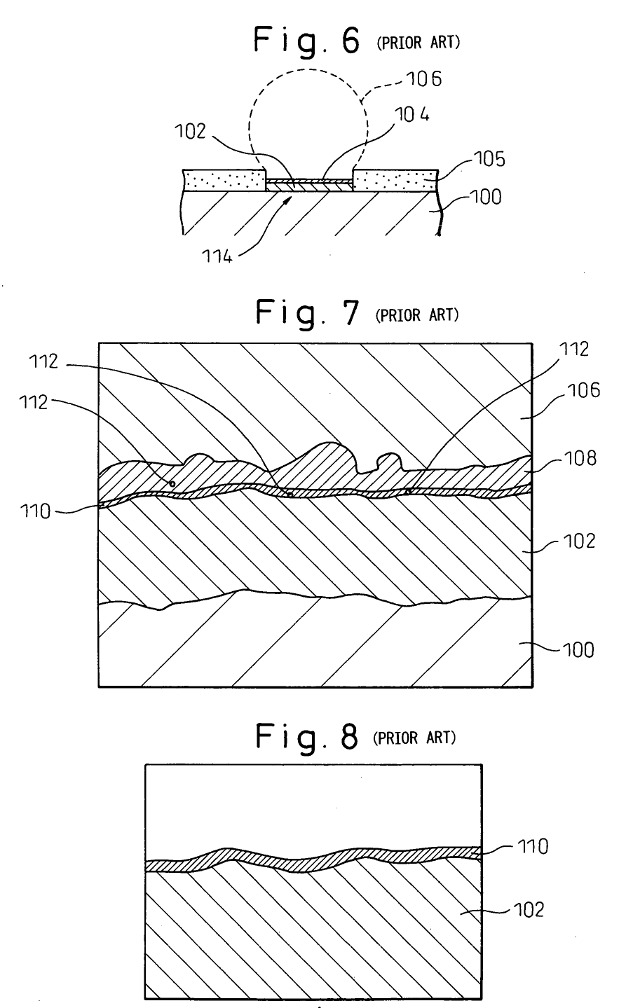

The tensile strength of the resultant solder bump 20 is further improved compared to that of the solder bump 106 mounted to the conventional pad 114 shown in FIG. 6. It is supposed that this improvement in tensile strength of the solder bump 20 may be derived from the following:

When the solder ball mounted on the surface of the pad 40 shown in FIG. 1 is subjected to the reflowing treatment, gold (Au) in the gold layer 16 first diffuses in the molten solder, then copper (Cu) in the copper layer 14 diffuses in the molten solder and is mixed with Sn in the molten solder to result in the Sn—Cu alloy layer. Thereafter, the diffusion speed and amount of nickel from the nickel layer to the molten solder is controllable by this Sn—Cu alloy layer. Accordingly, it is possible to make uniform the building speed of the Sn—Cu alloy layer and to prevent the P-rich layer from being formed as much as possible, whereby the generation of micro-voids in the Sn—Cu alloy layer is restricted.

According to the multi-layer plated structure of the pad 40 shown in FIG. 1, the tensile strength of the solder bump 20 mounted to the pad 40 is improved compared to the conventional multi-layer plated structure of the prior art pad 114 shown in FIG. 6.

While the copper layer 14 is directly formed by the electroless plating on the surface of the P-contained nickel layer 12 in the multi-layer plated structure of the pad 40 shown in FIG. 1, there may be a case wherein it is difficult to directly form the copper layer 14 on the surface of the P-contained nickel layer 12 by electroless plating. In such a case, as shown in FIG. 2, after a gold layer 16a has been formed on the P-containing nickel layer 12 by the electroless gold plating, the copper layer 14 can be easily formed on the gold layer 16a by the electroless copper plating. On the copper layer 14 thus obtained, the gold layer 16 is formed by electroless gold plating for the purpose of improving the resistance to corrosion and the resistance to acid, in the same manner as shown in FIG. 1.

In the pad 40, shown in FIG. 2, obtained in such a manner, a thickness of the nickel layer 12 is larger than that of the copper layer 14 which is larger than that of the gold layer 16, while the gold layer 16 has a thickness approximately equal to that of the gold layer 16a.

In this regard, the gold layers 16, 16a may have a thickness equal to or larger than that of the copper layer 14, or the gold layers 16 and 16a may be different in thickness from each other.

The solder bump 20 can be formed by mounting the solder ball on the surface of the pad 40 shown in FIG. 2 and subjecting the same to the reflowing treatment. The tensile strength of this solder bump 20 is improved more than that of the solder bump 106 mounted to the prior art pad 114 shown in FIG. 6. It is thought that reasons for the improvement in tensile strength of this solder bump 20 are the same as in a case of the pad 40 shown in FIG. 1.

Note that gold (Au) in the gold layer 16a formed between the copper layer 14 and the P-contained nickel layer 12 when the solder ball mounted on the pad 40 shown in FIG. 2 is subjected to the reflowing treatment is thought to diffuse into the copper layer 14 and the molten solder.

According to a circuit board for a semiconductor device or others in which the pads 40 shown in FIG. 1 or 2 are arranged at one end of a conductor pattern, it is possible to improve the tensile strength of the bump 20 formed as an external connection terminal. Thus, when the circuit board for the semiconductor device or others is mounted to a substrate via the bumps 20 formed as external connection terminals, the circuit board can be rigidly mounted to the substrate to enhance the reliability of the finally assembled electronic equipment.

In the present invention, the above-mentioned gold layers 16 and/or 16a may be replaced by palladium (Pd) layers or a platinum (Pt) layers.

Also, instead of the solder ball, a foreign member such as an external connection terminal may be soldered to the pad 14.

### EXAMPLE 1

Pads were formed of copper at one end of a circuit pattern provided on one surface of a multi-layer substrate consisting of a plurality of insulation layers of epoxy resin laminated with each other, and a surface of the pad was covered with solder resist 18 except for part in which a solder bump 20 is to be mounted as an external connection terminal. The surface of the pad 40 was exposed as a circular shape 470 μm in diameter.

After a preliminary treatment, such as degreasing, has been done on the exposed surface of the pad, the multi-layer substrate was dipped for 30 minutes in an electroless nickel-plating solution of hypophosphorous acid-contained sulfuric acid prepared so that the concentration of phosphorus compound is in a range from 6 to 8% by weight. Thus, the P-contained nickel layer 12 of 5 μm thick was formed on the exposed surface of the pad.

After the multi-layer substrate having the nickel layer 12 on the exposed surface of the pad was rinsed, the substrate was dipped for 5 minutes in an electroless cyan gold plating solution of a nickel-replacement type (reduction type) to form the gold layer 16a of 0.04 μm thick on the nickel layer 12.

Further, the multi-layer substrate was dipped for 10 minutes in an electroless copper plating solution of a reduction EDTA type to form the copper layer 14 of 0.4 μm thick on the gold layer 16a, after which it was dipped for 20 minutes in an electroless cyan gold plating solution of a copper-replacement type (reduction type) to form the gold layer 16 of 0.05 μm thick on the copper layer 14.

By such a series of electroless plating processes, the pad 40 shown in FIG. 2 was formed, on the exposed surface of the pad, and consisted of the P-contained nickel layer 12 of 5 μm thick, the gold layer 16a of 0.04 μm thick, the copper layer 14 of 0.4 μm thick and the gold layer 16 of 0.05 μm from the bottom to the top thereof.

Then, a solder ball of 0.6 mm diameter (Sn (95.5% by weight)—Ag (4% by weight)—Cu (0.5% by weight)) was placed on the surface of the pad 40 formed on the multi-layer substrate shown in FIG. 2 and subjected to the reflowing treatment while using a rosin type flux in the nitrogen atmosphere at the maximum temperature of 250° C. As a result, the solder bump 20 was formed on the pad 40 shown in FIG. 2.

### COMPARATIVE EXAMPLE

In the same manner as in Example 1, except for eliminating the gold layer 16a and the copper layer 14, the pad 114 shown in FIG. 6 was formed, having the P-contained nickel layer 102 of 5 μm thick on the exposed surface of the pad and the gold layer 104 of 0.05 μm thick formed on the former.

Then, a solder ball of 0.6 mm diameter (Sn (95.5% by weight)—Ag (4% by weight)—Cu (0.5% by weight)) was placed on the surface of the pad 114 formed on the multi-layer substrate shown in FIG. 6 and subjected to the reflowing treatment while using a rosin type flux in the nitrogen atmosphere at the temperature of 250° C. As a result, the solder bump 106 was formed on the pad 114 shown in FIG. 6.

### COMPARISON OF EXAMPLE 1 WITH COMPARATIVE EXAMPLE

The tensile strength of the bumps 20 and 106 prepared by Example 1 and Comparative Example was measured by using the tensile strength tester proposed in Japanese Unexamined Patent Publication (Kokai) No. 11-288986.

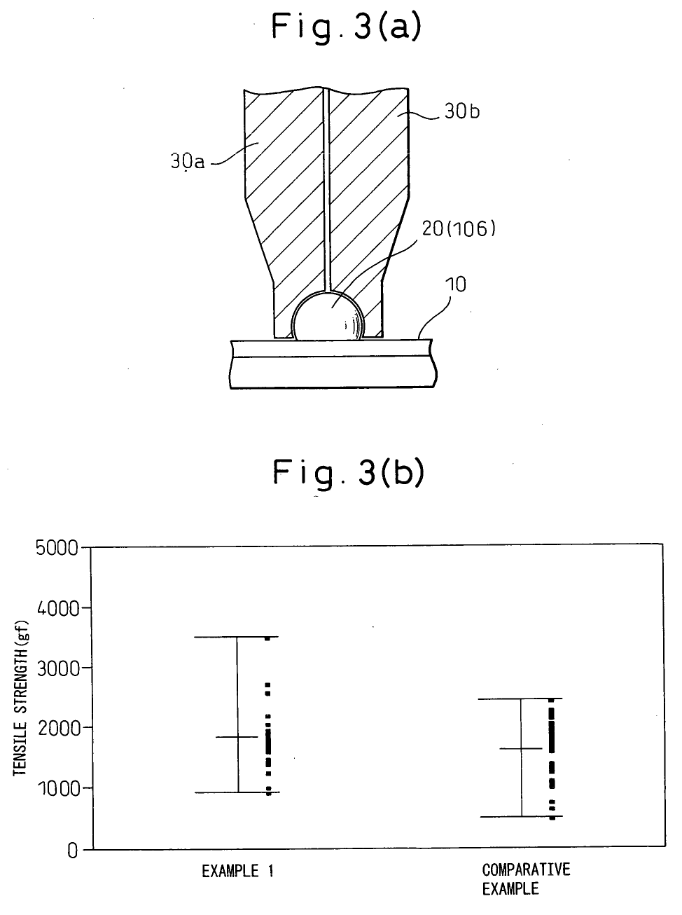

As shown in FIG. 3(a), during the measurement of the tensile strength, the solder bump 20 (106) was gripped by a pair of clamps 30a and 30b in the tensile strength tester while taking care not to crush the solder bump 20 thereby and then the bump was drawn out from the pad by the movement of clamps 30a and 30b, and the force necessary for the drawing was measured as a tensile strength. 30 samples of each the solder bump 20, 106 were tested, results of which were shown in FIG. 3(b) as the dot-distribution of the measured values of 30 samples, respectively.

As apparent from FIG. 3(b), the tensile strength of the solder bump 20 in Example 1 is improved compared to that of the solder bump 106 in Comparative Example.

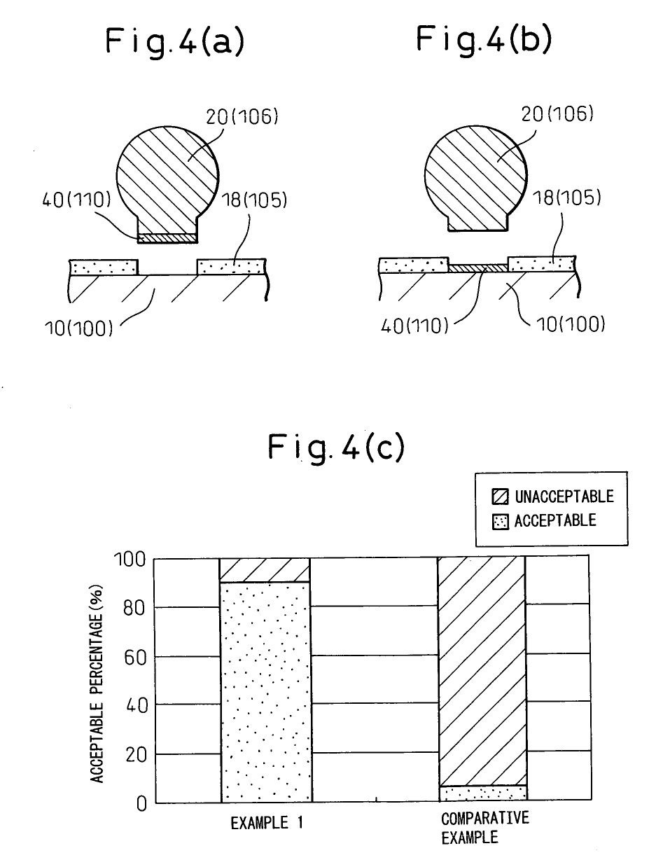

The appearance of the drawn-out solder bump 20 (106) was also observed. That is, as shown in FIG. 4(a), when the pad 40 (114) is adhered to the drawn-out bump 20 (106), the debonding of the solder bump 20 (106) is not caused by the defect in the P-rich layer 110 formed in the boundary between the pad 40 (114) and the bump 20 (106); i.e., there are no problems in the multi-layer plated structure of the pad 40 (114). The state shown in FIG. 4(a) was referred to as an acceptable state (acceptable mode).

Contrarily, if the pad 40 (114) is not adhered to the drawn-out solder bump 20 (106) as shown in FIG. 4(b), the debonding of the solder bump 20 (106) is caused by micro-voids formed in the boundary between the pad 40 (114) and the bump 20 (106); i.e., there are any problems in the multi-layer plated structure of the pad 40 (114). The state shown in FIG. 4(b) was referred to as an unacceptable state (unacceptable mode).

Also, in the appearance of such a drawn-out solder bump 20 (106), the 30 samples in each of Example 1 and Comparative Example were observed, results of which were illustrated in FIG. 4(c).

As apparent from FIG. 4(c), 90% of the drawn-out solder bumps 20 in Example 1 are in the acceptable state (acceptable mode) shown in FIG. 4(a). Contrarily, approximately 10% of the drawn-out solder bumps 106 in Comparative Example are in the acceptable state (acceptable mode) shown in FIG. 4(a).

### EXAMPLE 2

Example 2 was prepared based on the plated structure in the above-mentioned Example 1, in which a thickness of the nickel layer 12 (5 μm) and that of the gold layer 16a (0.04 μm) formed thereon are the same as in Example 1, but a thickness of the copper layer 14 was varied in the following manner, while a thickness of the gold layer 16 (0.05 μm) formed thereon is the same as in Example 1. Example 2 was compared with the Comparative Example in which a thickness of the nickel layer 102 is 5 μm and that of the gold layer 104 formed thereon is 0.05 μm.

The test results are as shown in the following Table 1.

TABLE 1

| | Thickness of Cu layer | | | | | |
|---|---|---|---|---|---|---|
| | None | | | | | |
| | (Com. Ex.) | 0.2 μm | 0.4 μm | 0.6 μm | 0.8 μm | 1 μm |
| Acceptable | 6.6% | 67% | 90% | 40% | 20% | 0% |
| percentage | | | | | | |

* Acceptable mode is shown in FIG. 4 (a), and unacceptable mode is shown in FIG. 4 (b).

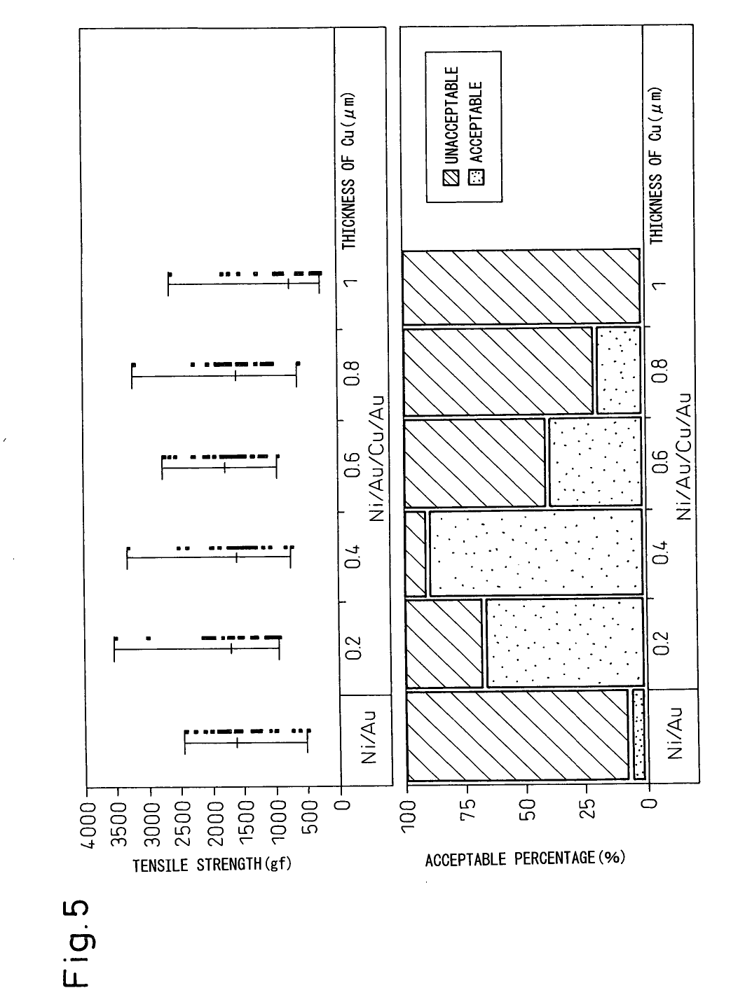

The above-mentioned test results are shown in FIG. 5. From this, it is apparent that a thickness of the copper layer is preferably in a range from 0.2 to 0.6 μm, most preferably 0.4 μm.

In this regard, in the pad structure shown in FIG. 2, the gold plating layer 16a provided between the nickel plating layer 12 and the copper plating layer 14 is made to be extremely thin so that the nickel and the copper are in close contact with each other. Therefore, it is thought that this gold plating layer does not especially contribute to the improvement of the tensile strength.

Thus, it is expected that the plated structure shown in FIG. 1 will have the same test results as in the plated structure shown in FIG. 2.

By the way, the gold plating layer 16 on the outer surface is made to be extremely thin for the purpose of preventing the copper plating layer 14 from being oxidized, whereby it is thought that this gold plating layer also does not especially contribute to the improvement of the tensile strength.

While the present invention has been described based on the preferred embodiments with reference to the attached drawings, the present invention should not be limited thereto but can be variously changed and modified without departing from a spirit or a scope of the present invention.

### CAPABILITY OF EXPLOITATION IN INDUSTRY

As described hereinabove, according to the present invention, it is possible to constitute the boundary between the solder bump and the pad by a dense layer so that the tensile strength of the solder bump is improved. Accordingly, the tensile strength of the solder member such as a solder ball mounted to the pad, or a foreign member soldered thereto is improved to facilitate the reliability of a finally assembled electronic equipment.

What is claimed is:

1. A pad structure for a circuit board provided in a conductor pattern, to which a solder member such as a solder ball is mounted or a foreign member is soldered, having a multi-layer plated structure comprising
a metal layer formed as part of said conductor pattern to be a pad body,
a phosphorus-containing nickel layer formed by an electroless nickel plating to be directly brought into contact with said metal layer,
a copper layer thinner than said nickel layer, formed on said nickel layer by an electroless copper plating, and
a precious metal layer formed on said copper layer by an electroless precious metal plating.

2. A pad structure for a circuit board as defined by claim 1, wherein said metal layer forming the pad body is formed of copper, and said precious metal layer is formed of gold, palladium or platinum.

3. A pad structure for a circuit board provided in a conductor pattern, to which a solder member such as a solder ball is mounted or a foreign member is soldered, having a multi-layer plated structure comprising
a metal layer formed as part of said conductor pattern to be a pad body,
a phosphorus-containing nickel layer formed by an electroless nickel plating to be directly brought into contact with said metal layer,
a first precious metal layer formed on said nickel layer by an electroless precious metal plating,
a copper layer thinner than said nickel layer, formed on said first precious metal layer by an electroless copper plating, and
a second precious metal layer formed on said copper layer by an electroless precious metal plating.

4. A pad structure for a circuit board as defined by claim 3, wherein said metal layer forming the pad body is formed of copper, and said first or second precious metal layer is formed of gold, palladium or platinum.

5. A circuit board comprising
a substrate body,
a conductor pattern formed on said substrate body, having a pad in part thereof on which a solder member such as a solder ball is to be mounted or a foreign member is to be soldered, wherein
said pad comprises
a metal layer formed as part of said conductor pattern to be a pad body,
a phosphorus-containing nickel layer formed by an electroless nickel plating to be directly brought into contact with said metal layer,
a copper layer thinner than said nickel layer, formed on said nickel layer by an electroless copper plating, and
a precious metal layer formed on said copper layer by an electroless precious metal plating.

6. A circuit board as defined by claim 5, wherein said metal layer forming the pad body is formed of copper, and said precious metal layer is formed of gold, palladium or platinum.

7. A circuit board comprising
a substrate body,
a conductor pattern formed on said substrate body, having a pad in part thereof on which a solder member such as a solder ball is to be mounted or a foreign member is to be soldered, wherein
said pad comprises
a metal layer formed as part of said conductor pattern to be a pad body,
a phosphorus-containing nickel layer formed by an electroless nickel plating to be directly brought into contact with said metal layer,
a first precious metal layer formed on said nickel layer by an electroless precious metal plating,
a copper layer thinner than said nickel layer, formed on said first precious metal layer by an electroless copper plating, and
a second precious metal layer formed on said copper layer by an electroless precious metal plating.

8. A circuit board as defined by claim 7, wherein said metal layer forming the pad body is formed of copper, and said first or second precious metal layer is formed of gold, palladium or platinum.
